(19) United States
(12) Patent Application Publication
(10) Pub. No.: US 2006/0032066 A1
(43) Pub. Date: Feb. 16, 2006

(54) Multifunction measuring square

(76) Inventor: Michael Nicholson, Upper Darby, PA (US)

Correspondence Address: John A. Parrish;Law Offices of John A. Parrish, Suite 300, Two Bala Plaza, Bala Cynwyd, PA, 19004, US

(21) Appl. No.: 11/179,336

(22) Filed: Jul. 12, 2005

Related U.S. Application Data
(60) Provisional application No. 60/587,220, filed on Jul. 12, 2004.

(51) Int. Cl. B43L 7/10

(52) U.S. Cl. 33/471

(57) ABSTRACT

The disclosed invention relates to a multi-function measuring square 1. The measuring square may be used for any of a Bevel Square, Framing Square, T-Square or Speed Square. The measuring square includes a blade 5 adapted for rotation relative to a housing 10 formed of a right housing member 10R and a left housing member 10L. A diagonal support arm 50 is included to support blade 5 at a at desired position relative to the housing 10. The square includes a recess for storage of blade 5 when the housing members are operatively connected to form housing 10 and a recess for storage of diagonal support arm 50.

This application claims priority to U.S. Provisional Application 60/587,220 filed Jul. 12, 2004.

### BACKGROUND OF THE INVENTON

In the building trades, four types of measuring squares are well known. These include the Bevel Square, the Framing Square, the Tee-Square and the Speed Square. The Bevel Square includes an adjustable blade for transferring angles. The Framing Square includes a fixed, 90° blade for square alignments and for cutting layouts for roof and stair framing. The T-Square is primarily used for 90° off-edge marking and cutting of building materials. The Speed Square includes a fixed triangular shaped member that includes 45° and 90° angles for marking angled cuts in roof framing.

Although these four types of measuring squares of the prior art have proven useful, the utility of any one type of these squares is limited by its design to work with angles. Consequently, all four types of these squares do not directly assign a specific measurement to an angle. This causes added complexity in taking measurements and subsequent cutting of materials. A need therefore exists for a measuring square which overcomes these disadvantages and provides a tool that shows precise angle measurements.

### SUMMARY OF THE INVENTION

The invention relates to a novel, multi-function measuring square that may be used to perform the functions of any of a Bevel Square, Framing Square, T-Square or Speed Square.

In one aspect, a kit for use in constructing a multi-function measuring square 1 is provided. The kit includes blade 5 adapted for rotation relative to housing 10. Housing 10 includes right housing member 10R and a left housing member 10L. The housing members having one or more openings therein for receiving one or more fasteners adapted to secure blade 5 between the housing members when the housing members are operatively connected to form housing 10. The kit also includes a right faceplate 20R adapted to engage housing member recess 10E in right housing member 10R, a left faceplate 20L adapted to engage housing member recess 10E in left housing member 10L, a washer 30 adapted to engage any of the right face plate 20R and the left face plate 20L, a right end plate 60R adapted to be received on right housing member 10R and a left end plate adapted to be received on right housing member 10L, and a diagonal support arm 50 adapted for connection to housing member 10R to retain blade 5 at position relative to the housing 10. Housing member 10R further includes a recess for storage of diagonal support arm 50. Blade 5 includes at least one hole to enable blade 5 to be secured to arm 50 to locate blade 5 at a predetermined angle of any of 22.5°, 45° or 90° relative to housing 10. Left housing member 10L includes T-square notch 10N adapted to retain blade 5 at 90° relative to housing 10. diagonal support arm 50 can include scale 50S thereon. Blade 5 also may include elongated slot 99 that has recesses adapted for enabling blade 5 to be secured to arm 50 at a desired angle relative to housing 10.

Multi-function measuring square 1 includes blade 5 adapted for rotation relative to housing 10 formed by right housing member 10R and left housing member 10L. A right faceplate 20R is secured to right housing member 10R, and left faceplate 20L is secured to left housing member 10L. A washer 30 can be secured over any of face plates 20R, 20L. The left housing member 10L includes T-square notch 10N adapted to retain blade 5 at 90° relative to housing 10. The measuring square also can include a diagonal support arm 50 adapted 10R to retain blade 5 at a desired position relative to the housing 10. The multi-function measuring square can include a recess for storage of blade 5 in housing 10. Housing member 10R can include a recess for storage of diagonal support arm 50. Blade 5 can include at least one hole to enable blade 5 to be secured to arm 50 so as to locate blade 5 at a predetermined angle of any of 22.5°, 45° or 90° relative to housing 10. Blade 5 also can include an elongated slot 99 having recesses adapted for enabling blade 5 to be secured to arm 50 at a desired angle relative to housing 10.

### BRIEF DESCRIPTION OF THE DRAWINGS

FIG. 1 is a side view of the multi-function measuring square configured for use as a Bevel Square;

FIG. 2 is a side view of the multi-function measuring square configured for use as a Framing Square;

FIG. 3 is a side view of the multi-function measuring square configured for use as a Speed Square;

FIG. 4 is a side view of the multi-function measuring square configured for use as a Tee Square.

FIG. 5 is an exploded assembly view of the multi-function measuring square;

FIG. 6 is a perspective view of housing components of the multi-function measuring square that shows notch in housing member for use as a T-square.

FIG. 7 is a side view of the multi-function measuring square configured as a speed square that shows diagonal scale arm in an extended position for use in multi-function measuring an angle a;

FIG. 8 is an exploded assembly view of an alternative embodiment of the multi-function measuring square;

FIG. 9 is shows an alternative embodiment wherein an elongated slot is provided in the blade of the multi-function measuring square.

FIG. 10 shows an alternative embodiment of the diagonal support arm of the multi-function measuring square.

### DETAILED DESCRIPTION OF THE INVENTON

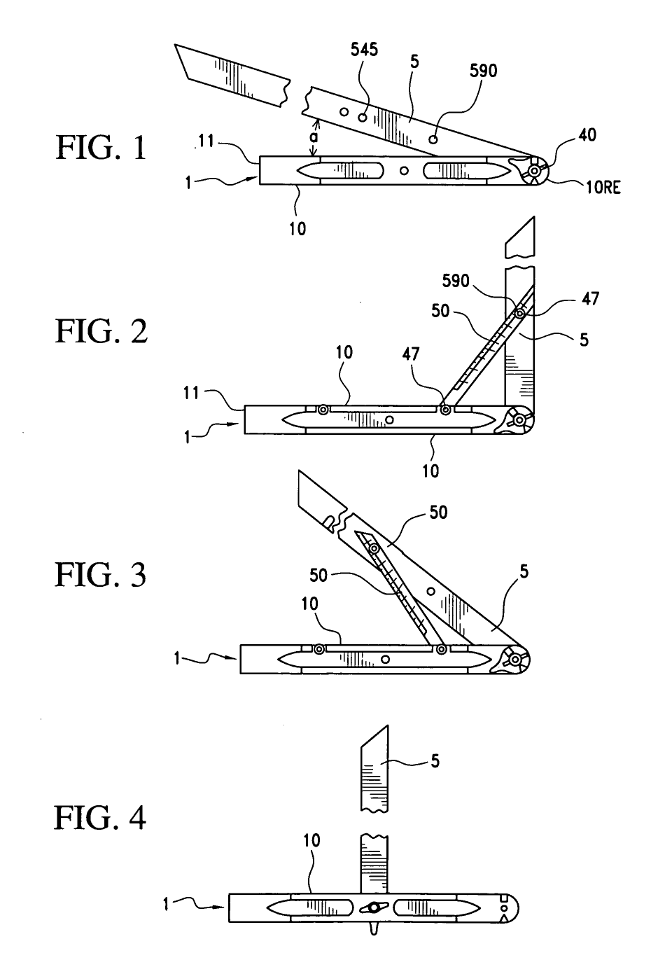

In a first embodiment of multi-function measuring square 1, as shown in FIG. 1, multi-function measuring square 1 is configured for use as a bevel square. In this embodiment, multi-function measuring square 1 may be used to transfer angles for use in cutting of materials such as lumber for, such as, roof framing.

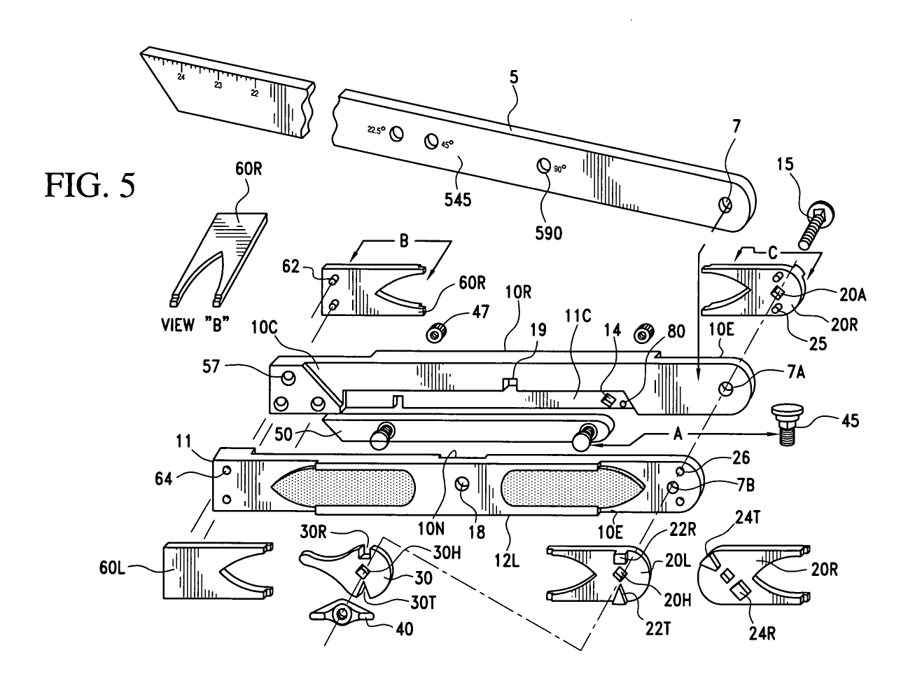

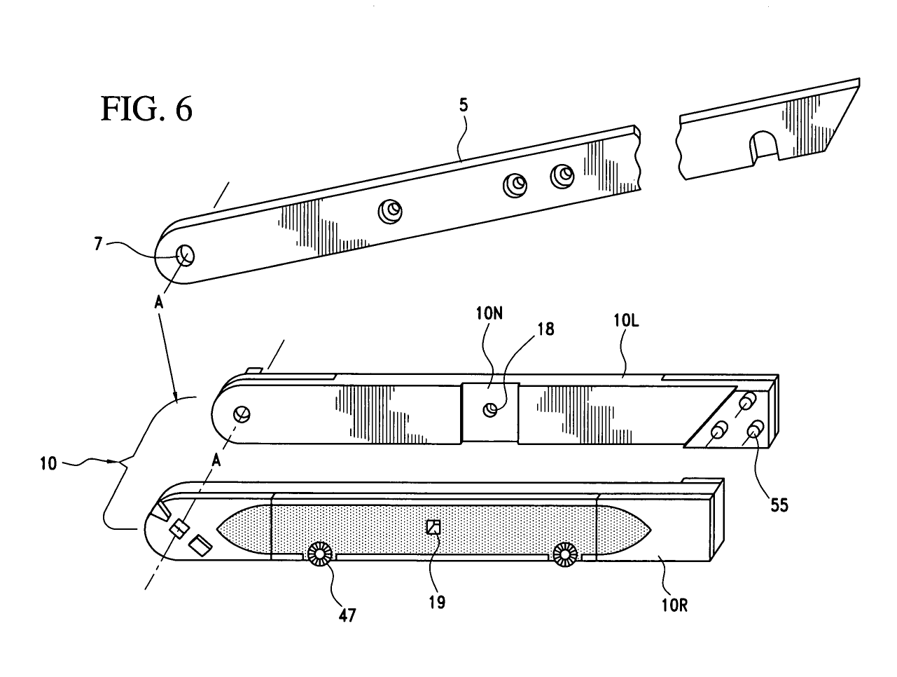

As shown in FIGS. 1 and 5, blade 5 can be relative to housing 10 to a desired angle a as shown in FIG. 1, between housing 10 and blade 5. As shown in FIGS. 1 and 5, housing 10 includes round end portion 10RE and opposite polygonal, preferably rectangular end portion 11. Blade 5 can be stored in storage cutout 10C in housing 10.

Housing 10, as shown in more detail in FIG. 5, includes right housing member 10R and left housing member 10L. Housing members 10R, 10L are joined together by fasteners and pins. As shown in FIGS. 5 and 6, a fastener such as bolt 15, preferably in the form of a carriage bolt, is passed through opening 20A in right faceplate 20R, through hole 7A of member 10R, through hole 7 of blade 5, through hole 7B in housing member 10L, through hole 20H in left faceplate 20L and through opening 30H of washer 30 prior to receiving housing nut 40, preferably in the form of a wing nut, to secure 10R, 10L together. Face plates 20R, 20L are configured to engage housing member recesses 10E, as shown in FIG. 5, in right and left housing members 10R, 10L. Left face plate 20L includes one or more nubs such as 22R, 22T for engaging corresponding slots 30R, 30T in washer 30. Nubs 22R, 22T may have a wide range of shapes such as circular and polygonal and combinations thereof. Preferably, one of the nubs such as 22R is rectangular and one of the nubs such as 22T is triangular. Nubs 22R, 22T preferably are configured on faceplate 20L to be perpendicular to the bottom edge of housing 10 when faceplate 20L is joined to housing member 10L. Faceplate 20R also can include one or more nubs such as 24R, 24T. Nubs 24R, 24T may have a wide range of shapes such as circular and polygonal and combinations thereof. Preferably, one of the nubs such as 24R is rectangular and one of the nubs such as 24T is triangular. Nubs 24T, 24R are preferably configured to be at 45° to the bottom edge of housing 10 when faceplate 20R is joined to housing member 10R. Housing members 10R, 10L each include pin receiving holes 26 for receiving faceplate pins 25 on each of face plates 20R, 20L to align faceplates 20R, 20L with housing members 10R, and 10L. Washer 30 includes one or more notches 30R and 30T adapted to engage nubs 22R and 22T, or 24R and 24T respectively. Housing members 10R, 10L as shown in FIG. 1 and 5, each include storage cutout 10C for storing blade 5. Housing member 10R also includes diagonal arm 50 storage recess 11C for receiving diagonal support arm 50. Support arm 50 is stored in housing member 10R by bolts 45 and fasteners such as thumb nuts 47. The polygonal end sections 11 of housing members 10R, 10L, as shown in FIGS. 5 and 6, are aligned by housing member pins 55 in member 10L. Housing member pins 55 mates with housing member pen recesses 57 in housing member 10R. Housing member right end plate 60R and housing member left end plate 60L may be joined to members 10R, 10L, respectively by end plate pins 62 which engage holes 64.

All of the components used in multi-function measuring square 1 may be made by well known processes such as casting and machining. The components may be made from a variety of materials such as metal, plastic and wood.

When multi-function measuring square 1 is used as a bevel square as in FIG. 1, nut 40 is loosened so that blade 5 may move freely. Blade 5 is positioned to a desired angle a and secured in place by tightening nut 40.

In a second embodiment, and as shown in FIGS. 2 and 5, multi-function measuring square 1 is configured for use as a framing square. In this embodiment, blade 5 is secured at 90° to housing 10 by diagonal arm 50. Arm 50 is secured to 90° positioning hole 590 in blade 5 and to support hole 14 in housing member 10R by bolts 45 and nuts 47.

When multi-function measuring square 1 is employed as a framing square for use in, such as, house framing, the bottom of housing 10 is placed against an edge of a board such as a two by four. Blade 5 then is aligned at 90° against a secure perpendicular wall plate. The two by four then is aligned with blade 5 and then secured to the floor to yield a floor plate that has two square inside corners.

In a third embodiment, and as shown in FIGS. 3 and 5, multi-function measuring square 1 is configured for use as a speed square to mark materials to be cut at 45° angles. In this embodiment, blade 5 is secured at 45° to housing 10 by arm 50. Arm 50 is secured to 45° positioning hole 545 in blade 5 and to support hole 14 in 10R by bolts 45 and nuts 47. When multi-function measuring square 1 is employed as a speed square, the top edge of housing 10 is placed against the outside edge of an object such as a floor tile so that blade 5 is at 45° to the outside edge of the tile. A line then may be marked against blade 5 onto the diagonal of the floor tile.

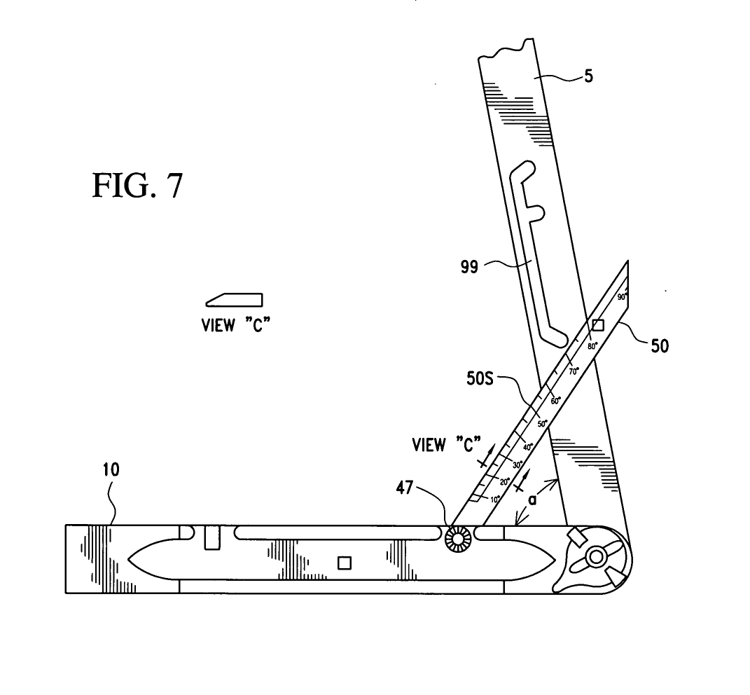

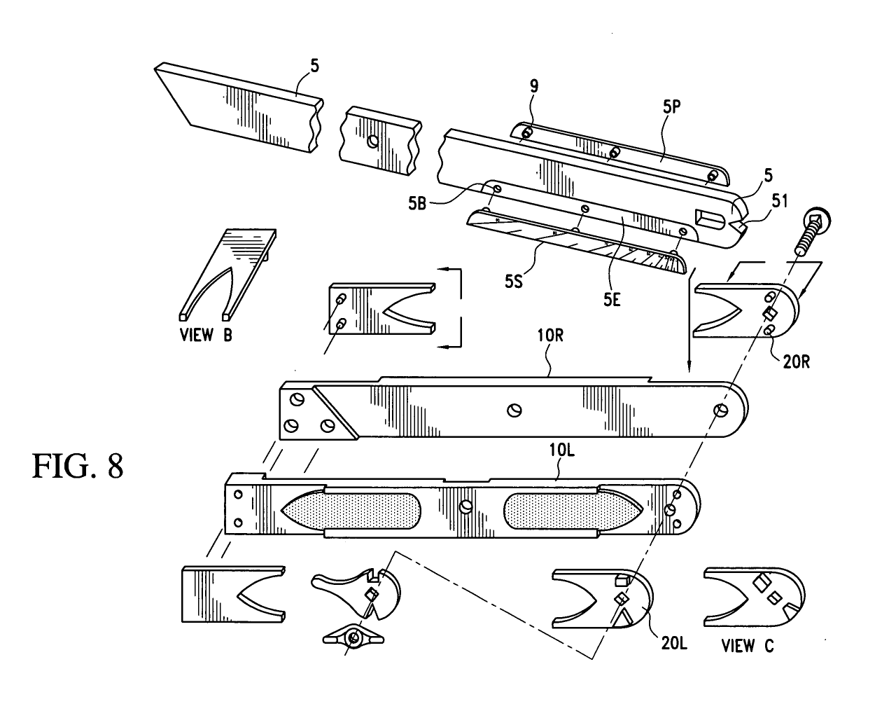

Multi-function measuring square 1 also may be used as a speed square to measure angles other than 45° angles. As shown in FIG. 7, arm 50 may include scale 50S thereon to measure angle a between blade 5 and housing 10. When multi-function measuring square 1 is used to measure an angle α, the outer edge of blade 5 is positioned against an edge of an object that is located at an angle α relative to the bottom of housing 10. Angle α, as shown in FIG. 7, is read at the intersection of scale 50S with the outside edge of blade 5.

In a fourth embodiment, as shown in FIGS. 4-6, multi-function measuring square 1 is configured for use as a T-Square. In this embodiment, blade 5 is located in T-Square notch 10N at the center of housing member 10L and at 90° to housing 10 as in FIGS. 2, and 4-6. A bolt such as bolt 15 is passed through T-Square opening 19 in housing member 10R, hole 7 of blade 5 and through notch hole 18 in notch 10N of housing member 10L. A nut such as nut 40 is used to secure housing members 10R, 10L to retain blade 5. In a preferred aspect, washer 30 is placed on blade 5 when located in T-Square notch 10N. In this aspect, bolt 15 is passed through T-Square opening 19 in housing member 10R, through hole 30H of washer 30, though hole 7 of blade 5 and through notch hole 18 of T-Square notch 10N of housing member 10L prior to receiving nut 40.

When multi-function measuring square 1 is used as a T-Square, the top edge of housing member 10 is held against an outside edge of an object such as wallboard. A marker such as a knife blade or pencil is traced against blade 5 to generate a line onto the object. This procedure may be applied to the opposite side of the wallboard to provide a score line for snapping the wallboard into pieces of desired length.

In a further embodiment of multi-function measuring square 1, as shown in FIG. 8, blade 5 includes scale blade recesses 5E for accepting scale plate 5S. Scale blade recess 5E includes scale blade recess holes 5B for receiving scale retaining plate pins 9 for engaging holes 5B to join plate 5P to scale plate 5S on blade 5. In this embodiment, blade 5 includes nub engagement notch 51, such as a triangular notch, for engaging a nub such as triangular nub 22T on face plate 20L to secure blade 5 at 90° to housing 10 or nub 24T on face plate 20R to secure blade 5 at 45° to housing 10.

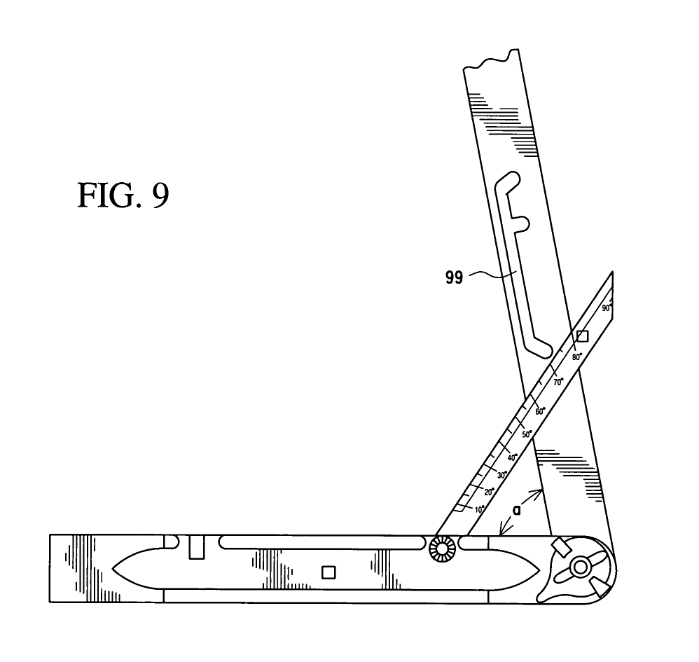

In an alternative embodiment, as shown in FIGS. 7, 9 and 10, blade 5 is provided with elongated slot 99 that has extensions at 22.5°, 45° and 90°. In this embodiment, blade 5 can be retained at a desired angle by positioning scale blade hole 50H over slot 99 and then passing a securing means such as a bolt and nut through hole 50H and slot 99.

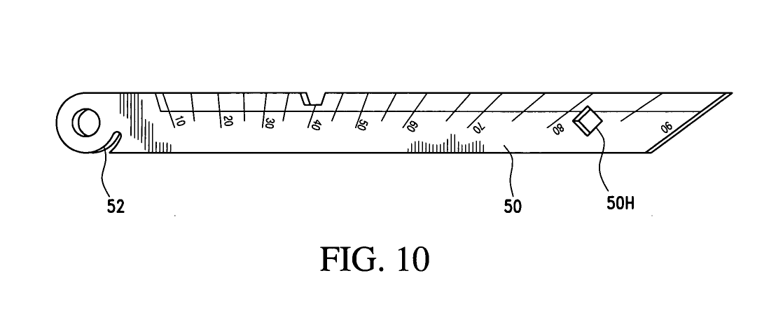

Arm 50, as shown in FIGS. 5 and 10 shows fixed pin 80 located in arm recess 11C of housing member 10R. Arm 50 can be moved to a precise location by causing curved slot 52 to move over fixed pin 80 in 10R.

The components described above employed in the multifunction measuring square and each of its various embodiments may be provided in the form of a kit that includes instructions for assembly.

1. A kit for use in constructing a multi-function measuring square 1 comprising,
a blade 5 adapted for rotation relative to a housing 10,
the housing 10 including a right housing member 10R and a left housing member 10L,
the housing members 10R, 10L having one or more openings therein for receiving one or more fasteners adapted to secure the blade 5 between the housing members 10R, 10L when the housing members 10R, 10L are operatively connected to form housing 10,
a right faceplate 20R adapted to engage housing member recess 10E in the right housing member 10R,
a left faceplate 20L adapted to engage housing member recess 10E in the left housing member 10L,
a washer 30 adapted to engage any of the right face plate 20R and the left face plate 20L,
a right end plate 6OR adapted to be received on the right housing member 10R and a left end plate adapted to be received on the left housing member 10L
and a diagonal support arm 50 adapted for connection to the right housing member 10R to retain the blade 5 at position relative to the housing 10.

2. The kit of claim 1 wherein the housing 10 includes a storage cutout 10C for storage of the blade 5 when the housing members 10R, 10L are operatively connected to form the housing 10.

3. The kit of claim 1 wherein housing member 10R further includes a recess for storage of the diagonal support arm 50.

4. The kit of claim 1 wherein the blade 5 includes at least one hole to enable blade 5 to be secured to diagonal support arm 50 to enable the blade 5 to be located at a predetermined angle of any of 22.5°, 45° or 90° relative to housing 10.

5. The kit of claim 1 wherein the left housing member 10L includes a T-square notch 10N adapted to retain blade 5 at 90° relative to housing 10.

6. The kit of claim 1 wherein the diagonal support arm 50 has a scale 50S thereon.

7. The kit of claim 1 wherein the blade 5 includes an elongated slot 99 having recesses adapted for enabling the blade 5 to be secured to the arm 50 at a desired angle relative to the housing 10.

8. The kit of claim 1 wherein the blade 5 includes a triangular slot 51 for engaging a nub on any of the face plate 20L and the face plate 20R.

9. The kit of claim 8 wherein the blade 5 includes a scale blade recess 5E for storage of a scale plate 5S.

10. A multi-function measuring square 1 comprising,
a blade 5 adapted for rotation relative to a housing 10,
the housing 10 including a right housing member 10R and a left housing member 10L,
the housing members 10R, 10L having one or more openings therein for receiving one or more fasteners adapted to secure the blade 5 between the housing members 10R, 10L when the housing members 10R, 10L are operatively connected to form the housing 10,
a right faceplate 20R adapted to engage a housing member recess 10E in the right housing member 10R,
a left faceplate 20L adapted to engage a housing member recess 10E in the left housing member 10L,
a washer 30 adapted to engage any of the right face plate 20R and the left face plate 20L,
a right end plate 60R adapted to be received on the right housing member 10R and a left end plate adapted to be received on the left housing member 10L,
and a diagonal support arm 50 adapted for connection to the housing member 10R to retain the blade 5 at position relative to the housing 10.

11. The multi-function measuring square of claim 10 further comprising,
a storage cutout 10C for storage of blade 5 when the housing members 10R, 10L are operatively connected to form the housing 10.

12. The multi-function measuring square of claim 10 wherein the housing member 10R further includes a recess 11C for storage of the diagonal support arm 50.

13. The multi-function measuring square of claim 10 wherein the blade 5 includes at least one hole to enable the blade 5 to be secured to the diagonal support arm 50 to locate the blade 5 at a predetermined angle of any of 22.5°, 45° or 90° relative to housing 10.

14. The multi-function measuring square of claim 10 wherein the left housing member 10L includes T-square notch 10N adapted to retain the blade 5 at 90° relative to housing 10.

15. The multi-function measuring square of claim 10 wherein the blade 5 includes an elongated slot 99 having recesses adapted for enabling blade 5 to be secured to the diagonal support arm 50 at a desired angle relative to housing 10.

16. The multi-function measuring square of claim 10 wherein the diagonal support arm includes a scale 50S thereon for measuring the angle of the blade 5 relative to the housing 10.

17. The multi-function measuring square of claim 10 wherein the blade 5 includes a slot 51 for engaging a nub on any one of the right face plate 20R and the left face plate 20L.

18. The multi-function measuring square of claim 17 wherein the blade 5 includes a scale blade recess 5E for storage of a scale blade 5S.
